(19) United States
(12) Patent Application Publication
(10) Pub. No.: US 2015/0142901 A1
(43) Pub. Date: May 21, 2015

(54) SYSTEMS AND METHODS FOR DELIVERING TIME-DELAYED ELECTRONIC NOTIFICATIONS

(71) Applicant: APT Technologies LLC, San Diego, CA (US)

(72) Inventors: Kristen M. Hon, San Diego, CA (US); Jesus Rodriquez II, San Diego, CA (US)

(21) Appl. No.: 14/510,068

(22) Filed: Oct. 8, 2014

Related U.S. Application Data
(60) Provisional application No. 61/888,781, filed on Oct. 9, 2013.

(51) Int. Cl. H04L 12/58

(52) U.S. Cl. CPC H04L 51/14; H04L 51/24
USPC 709/206

(57) ABSTRACT

This invention relates generally to the field of electronic messaging and notifications, and more particularly to systems and methods for creating and distributing time-delayed electronic messages and notifications on mobile devices. Preferred embodiments of the present invention provide systems and methods for creating electronic messages and notifications for time-delayed delivery, storing those messages locally on the sender's device and/or a receiver's device, and proving accompanying protocols for a time-delayed display on the receiver's mobile device or for later dispatch through the sender's device.

### TECHNICAL FIELD

This invention relates generally to the field of electronic messaging and notifications, and more particularly to systems and methods for creating and distributing time-delayed electronic messages and notifications on mobile devices.

### BACKGROUND AND SUMMARY

Since the popularization of the internet in the 1990s, people of all ages, backgrounds, and social strata have increasingly turned to this medium as their preferred mode of communication. In 2012, one study determined that approximately 25% of the world-wide population (including 61% of the U.S. population) use email. Another study determined that out of that group, approximately 85% of internet users send and receive email, and 62% communicate via social networking sites.

As the prevalence of electronic messages abound, people have increasingly relied upon centralized software to manage their daily affairs on their PCs, such as setting appointments and reminders. Examples of such software systems include proprietary systems (such as Microsoft Exchange & Outlook, Lotus Notes, Mozilla Thunderbird, etc.), web-based systems (such as those offered by Google, Yahoo, and Microsoft, etc), and other open source systems (such as open xChange and Citadel for Unix).

As people have increasingly turned to electronic communications and electronic personal data management, the market has demanded, and suppliers in turn, produced mobile devices that allow users to remain connected while away from their desktop PCs.

Indeed, there has been a rapid increase in sales of the number of portable computers, tablets, smartphones, and other devices that allow for mobile computing. For example, BI intelligence's forecasts indicate that mobile tablet sales (such as Microsoft's surface or the Apple's iPad)—a virtually non-existent market prior to 2010—is expected to reach 500 million units sold by 2015. Another study by Pew Research Center found that as of May 2013, 56% percent of all U.S. cell phones are smartphones (such as Android phones or iOS phones), which is a 20% increase form 2011.

However, operating systems and add-on software on many mobile devices lack the robustness and functionality to comparable software on personal computers. The reason for including “lite” software on mobile devices is many-fold. One reason is that these devices lack the storage capacity and processing power of personal computer, and thus, device makers believe it is important to keep the “amount” of software to a minimum. Additionally, mobile devices typically do not have the benefit of a “free” wired connection, and the constant exchange of data between these devices and wireless networks can have a devastating effect on the battery life and network use charges. Perhaps most importantly, the architecture of mobile software is staggeringly different than that contained on traditional personal computer operating systems, requiring new and innovative methods to achieve similar levels of functionality. The lack of mobile computing “robustness” explains the burgeoning development of new applications (“apps”) in the mobile computing market, such as found in the apple store, Google play, and in the Microsoft store.

Amongst the many features that have been excluded from mobile devices is the ability to send time-delayed messages. Consider, for example, that at 11:30 p.m. on Friday, a person remembers to write an email to his/her colleagues “reminding” them to attend a meeting at 10:30 a.m. on Monday. The writer believes that the message would be most effective if it was delivered at 8:45 a.m. on Monday morning. Assuming that the writer desired to send the a time delayed message, that function would typically be performed on a traditional personal computer which has an email client (such as Microsoft Outlook) running, wherein the message is “held” in abeyance until the trigger time (e.g., 8:45 a.m.). Because a traditional PC would be left on for 2.5 days while “wired” to the internet, the likelihood of transmission is virtually guaranteed. But requiring a person to use a traditional desktop computer is contrary to the benefits of mobile computing. Even for most robust devices, such as laptops, the likelihood of leaving it sitting idle contradicts its intended function—portability—which is completely obviated by leaving the device plugged in to an electrical outlet the entire time.

Compounding the problem is that mobile devices suffer from other limitations that would contravene the traditional method for sending a time-delayed communication. For example, smartphones and other mobile devices have limited battery capacity and may not be “on” when required. Or they may be purposefully “switched off” (when the sender is asleep, at a meeting, or traveling). Alternatively, these devices may not have internet access when required (such as found inside old buildings, non-coverage areas, or on an airplane).

In other words, mobile devices do not have the luxury of being left on indefinitely and/or having internet access at the exact moment of required dispatch. Thus, traditional methods of delivering time-delayed messages are deficient in mobile computing platforms.

Accordingly, an improved system and method for creating and distributing time-delayed electronic messages and notifications on mobile devices is desirable.

### SUMMARY OF THE INVENTION

To improve upon existing systems, preferred embodiments of the present invention provide a system and method for creating and distributing time-delayed electronic messages and notifications on mobile devices. One preferred system can include at least two consumer communication devices (e.g., a sender device and a receiver device) configured to send, receive, and display electronic communications, including without limitation, emails, appointment invitations, reminders, and other notifications (these electronic communications may be referred to herein, and in the figures, as “electronic communications” or “sticky note(s)” as further defined below). The system may also include a central server to which the sender device and/or receiver device connects over a data network. The sender device and/or receiver device is operatively coupled to a computer program product, the computer program product having a computer-usable medium including a sequence of instructions which, when executed by a processor, causes said processor to execute a process that sends and/or receives time-delayed communications, which is then displayed on the sender and/or received device at a specified time.

In addition, one preferred method for creating and distributing time-delayed electronic messages and notifications on mobile devices can include entering a message to one or more recipients with a future date and time of delivery (Message creation); coordinating delivery of the message through a central computer for display on the recipient(s) device(s) (Central computer corroboration); and instantaneous or time-delayed display of a notification (Message receipt). This method may use pull technology, or preferably, push technology to send and receive messages. As described below, the preferred method can further include verifying that an electronic notification has been received and/or displayed (verification). Other variations, features, and aspects of the system and method of the preferred embodiment are described in detail below with reference to the appended drawings.

The extent of corroboration of the central computer will depend largely upon whether the sender and receiver of the time-delayed message both have the instant invention and/or a compatible software on both devices (herein usually referred to as sender's and/or receiver's “ALF Application”; “ALF Application” is the proprietary name of a preferred embodiment of the present invention and has no specific industry meaning).

An illustration of the invention is helpful at this point: Assume that a sender desires to send a time-delayed “sticky note” (comprising an email, a calendar reminder, and an SMS message, in this instance) at 11:30 p.m. on Friday night, and both the sender and receiver have the present invention embodied in a software application running on their phones (i.e. the ALF Application). In this scenario, the sender would input the requisite detail (e.g., message: “meeting 8:30 am Monday, don't forget!”; delivery: Monday at 8:45 a.m.; recipients: Mr. Attendee). The ALF application would pass along this information to a central computer, which in turn would verify that the receiver has a corresponding software application (i.e. receiver's ALF Application), and in turn, would push the message to the recipient's phone. The message would reside on the recipient phone, held in abeyance, and only display at the appropriate time (e.g., 8:45 am). In the preferred method, verifications would be pushed back from the receiver device, via the central computer, in at least two instances: (1) upon receipt of the message (on Friday at 11:30 p.m., or as soon thereafter as practicable); and (2) upon display of the message on the recipient phone (on Monday at 8:45 a.m., or as soon thereafter as practicable).

In the alternative, if the central computer determines that the receiver does not possess the requisite ALF application, then the sender's phone would hold the message in abeyance until the appropriate time (e.g., 8:45 am Monday). In this scenario, the sender will receive at least one verification: confirmation that the message was sent (e.g., on Monday at 8:45 a.m., or as soon thereafter as practicable). If provided natively in the underlying messaging service, the sender may receive additional notification(s), such as confirmation that the message was successfully delivered.

The preferred embodiments of the present invention may also be used with other near field communication systems, such as near field communication (NFC) device readers, contactless (e.g., radio), and direct (e.g., electrical conduction) data exchange methodologies, radio frequency identification (RFID) tag readers, and so on, and the instant invention may be readily adapted to conform to such.

Moreover, the present invention may be adapted for use in a number of specialized uses, such as: (1) pharmacy (refill reminders for patients); (2) Medicine (reminder support for patients with Dementia and other memory disorders); (3) Education (course assignment planning and confirmation); (4) Business (appointment and task coordination); (5) Personal (task and event reminders); (6) Marketing (delayed mass push notifications by mobile devices); and (7) organizations (event planning and time-delayed notification for events).

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a schematic block diagram of a system used in connection with creating and distributing time-delayed electronic messages and notifications on mobile devices in accordance with a preferred embodiment of the present invention.

FIG. 2 is an example of the computerized screen of a user's home page as found on the preferred embodiment of present invention.

FIG. 3 is an example of the computerized screen of a user's messaging page as found on the preferred embodiment of present invention.

FIG. 4 depicts an overall flowchart illustrating an exemplary embodiment of a method by which time-delayed electronic messages and notifications on mobile devices are created and distributed.

FIG. 5 depicts an overall flowchart illustrating an exemplary embodiment of a method for message creation.

FIG. 6 depicts an overall flowchart illustrating an exemplary embodiment of providing verifications.

FIG. 7 depicts an overview logic flowchart illustrating an exemplary embodiment of a method for creating and distributing time-delayed electronic messages and notifications on mobile devices, along with failure protocols.

FIG. 8 depicts the fields contained in an exemplary embodiment of a STICKY NOTE.

### DEFINITIONS

The following definitions are not intended to alter the plain and ordinary meaning of the terms below but are instead intended to aid the reader in explaining the inventive concepts below:

As used herein, the term “SENDER DEVICE” shall generally refer to a mobile device such as a smart phone, personal digital assistant, laptop computer, notebook computer, tablet computer, smart TV, gaming console, streaming video player, or any other, suitable networking device having a web browser and/or stand-alone application configured to interface with and/or receive any or all data to/from the CENTRAL COMPUTER and/or one or more components of the preferred system 10. The sender device shall be considered in its broadest form, with any method of user input, including without limitation, touch, voice, gesture, vision, or other sensory user input.

As used herein, the term “RECEIVER DEVICE” shall generally refer to a mobile device such as a smart phone, personal digital assistant, laptop computer, notebook computer, tablet computer, smart TV, gaming console, streaming video player, or any other, suitable networking device having a web browser and/or stand-alone application configured to interface with and/or receive any or all data to/from the CENTRAL COMPUTER and/or one or more components of the preferred system 10. The receiver device shall be considered in its broadest form, with any method of user input, including without limitation, touch, voice, gesture, vision, or other sensory user input.

As used herein, the term “CENTRAL COMPUTER” shall generally refer to one or more sub-components or machines configured for receiving, manipulating, configuring, analyzing, synthesizing, communicating, and/or processing electronic messages and notifications associated with a user. Any of the foregoing subcomponents or machines can optionally be integrated into a single operating unit, or distributed throughout multiple hardware entities through networked or cloud-based resources. Moreover, the central computer may be configured to interface with and/or receive any or all data to/from the SENDER DEVICE, RECEIVER DEVICE, and/or one or more components of the preferred system 10.

As used herein, the term “NETWORK” shall generally refer to any suitable combination of the global Internet, a wide area network (WAN), a local area network (LAN), and/or a near field network, as well as any suitable networking software, firmware, hardware, routers, modems, cables, transceivers, antennas, and the like. Some or all of the components of the preferred system 10 can access the network through wired or wireless means, and using any suitable communication protocol/s, layers, addresses, types of media, application programming interface/s, and/or supporting communications hardware, firmware, and/or software.

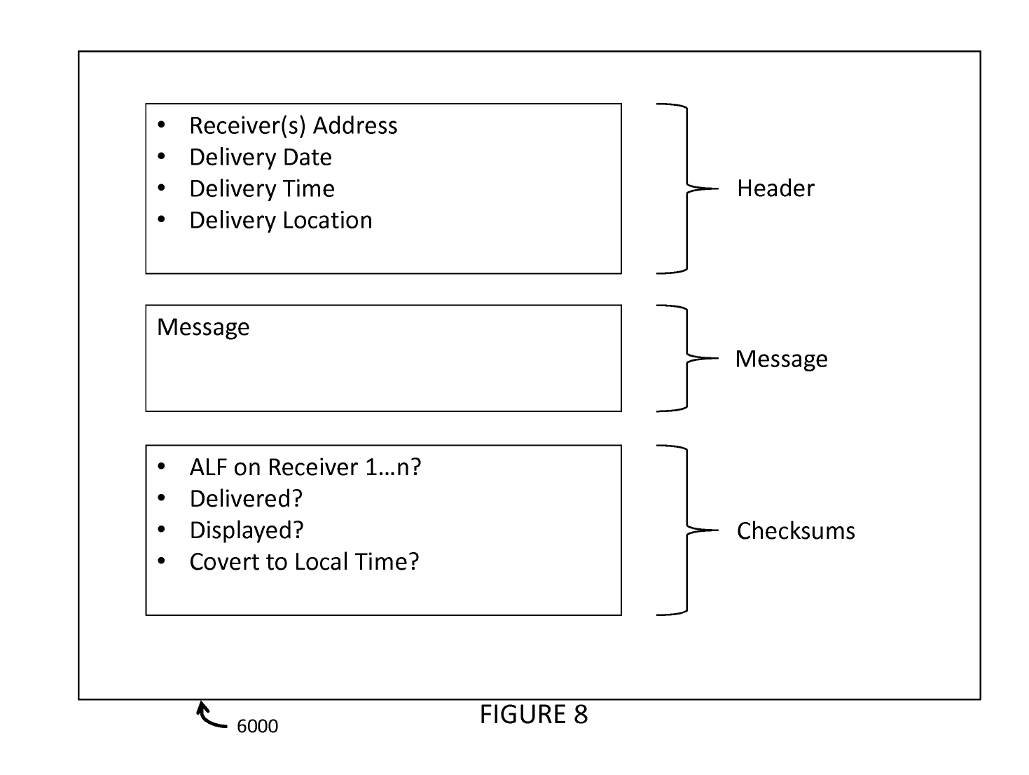

As used herein, the term “STICKY NOTE” shall generally refer to any form of electronic communication and notifications, whether live or delayed, including without limitation, email, SMS message (text message), voice message, video message, instant message, calendar reminder, pager message, blog post, bulletin board boast, social networking message or chat, news group post, or any other type of message that communication that takes place electronically. Sticky notes shall be considered in its broadest form, with any method of communication, including text, sound, tactile, or other sensory feedback that is used to communicate between people or machines, and containing any type content and/or attachment. Further, the STICKY NOTE may include one or more of the following parts: (a) a header; (b) a message or attachment; and (c) checksums. A STICKY NOTE's header information may include multiple fields, including, without limitation, the receipt's address, the date and time for delivery, and any other conditions necessary to satisfy before display. A STICKY NOTE's checksum may include a series of confirming bits, such as confirmation that the message has been displayed. An exemplary embodiment of the fields contained in a STICKY NOTE is shown in FIG. 8.

As used herein and in the claims, the singular forms “a,” “an,” and “the” include plural references unless the context clearly dictates otherwise.

Unless defined otherwise, all technical and scientific terms used herein have the same meanings as commonly understood by one of ordinary skill in the art.

### DETAILED DESCRIPTION OF PREFERRED EMBODIMENTS

The following description of the preferred embodiments of the invention is not intended to limit the invention to these preferred embodiments, but rather to enable any person skilled in the art to make and use this invention. Although any methods, materials, and devices similar or equivalent to those described herein can be used in the practice or testing of embodiments, the preferred methods, materials, and devices are now described.

The present invention relates to improved methods and systems for creating and distributing time-delayed electronic messages and notifications on mobile devices, which is most suitable for use with individuals, and shall be described as such throughout this document. Notwithstanding, the present invention may also be used by automated and/or manual systems employed by other types of entities including, but not limited to, corporations, companies, small businesses, and trusts, and/or any other recognized legal entities.

### System

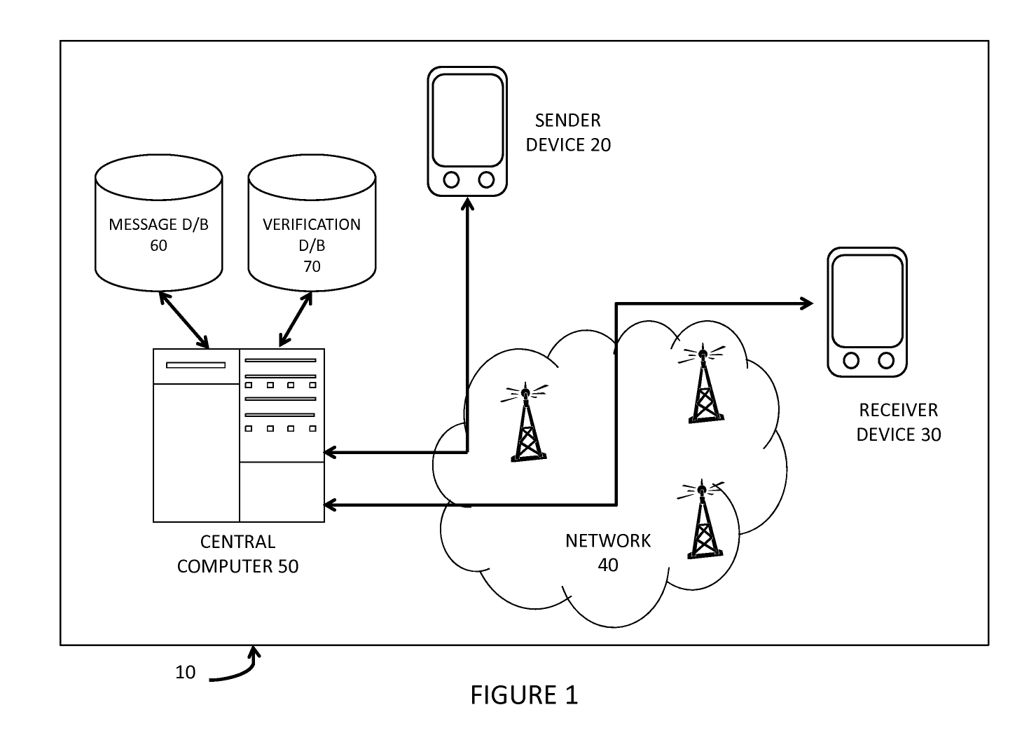

As shown in FIG. 1, a preferred operating environment for creating and distributing time-delayed electronic messages and notifications on mobile devices in accordance with a preferred embodiment can generally include a SENDER DEVICE 20, RECEIVER DEVICE 30, CENTRAL COMPUTER 50, and a NETWORK 40. In addition, the preferred system 10 can store messages and verifications logs in one or more databases, including for example, Message D/B 60 and Verification D/B 70. These databases may be populated by manual input by a user, or preferably by automated entry by data capture from each message transaction.

The preferred system 10 can include at least a SENDER DEVICE 20, a RECEIVER DEVICE 30, and a NETWORK 40 which (individually or collectively) function to provide creating and distributing time-delayed electronic messages and notifications on mobile devices by (a) creating messages for delayed delivery; and (b) placing those messages, directly or indirectly, on a recipient's mobile device for display at preset time, all based on a novel and unique set of processes and from a plurality of user choices. Moreover, the preferred system 10 functions to provide the sender with access to verifications that the receiver actually received the message (for later display) and/or that the message was displayed timely, all based on the novel and unique methodology described below.

### User Interface

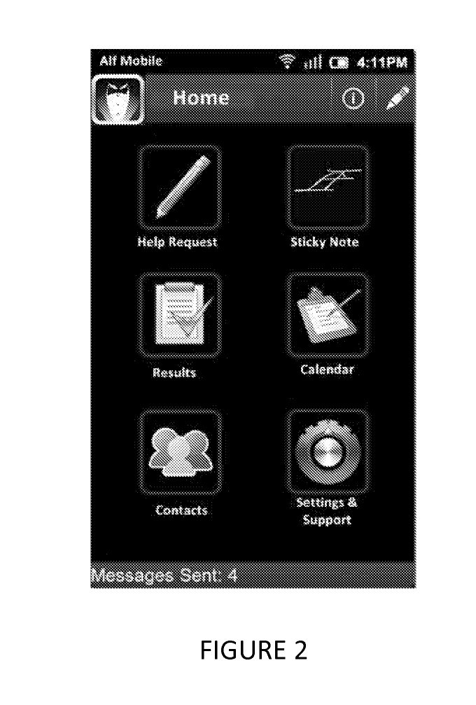

FIG. 2 is an example of a computerized screen as used with the present invention, wherein the user's menu screen and options are shown. Specifically, the menu screen provides a gateway to the user's account home page, which includes links to (1) get help; (2) send STICKY NOTES; (3) a “results” page which shows the status of future and past STICKY NOTES; (4) a calendar; and (5) access to the user's contact as stored on the SENDER DEVICE (which may be a completely independent list and/or interface with a global contact list on the device). Finally the menu screen allows the user to adjust his/her application's settings as well as access an online user guide (support).

Two additional features (not shown) may be included in the user interface as follows: First, the “results” page may include a dashboard which allows the sender to revive his or her user statistics (e.g., number of STICKY NOTES sent, delivered, cancelled, etc.). Second, the calendar feature may allow for help requests within events (such as mechanisms to resolve calendar conflicts). The calendar may also be shared amongst trusted users, which would allow potential senders to view/share the user's calendar, as set forth in the user preferences.

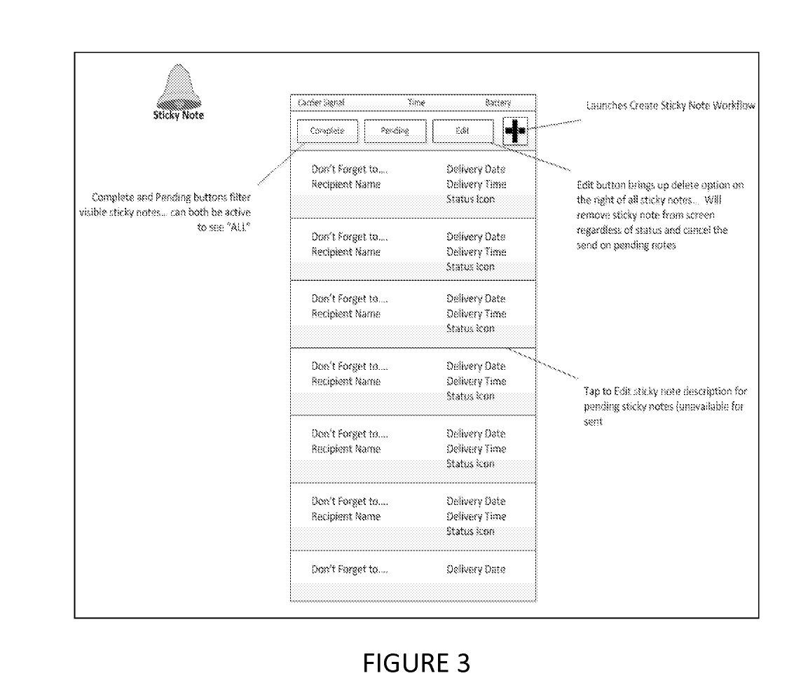

FIG. 3 is an example of an example of a computerized screen as used with the present invention, which is displayed when the user selects “STICKY NOTES” from the home screen. This screen contains two major sections: (1) a menu along the top bar; and (2) a scrolling list of pending and completed STICKY NOTES that the user has sent/is sending.

Contained within the top menu are two list filters (“complete” and “pending”) and an “edit” button. The “complete” button activates a filter on the STICKY NOTES list, whereby only fully transmitted STICKY NOTES are displayed. The second button, called “pending,” limits the resulting list to STICKY NOTES whose delivery and/or display has not completed. When both the “complete” and “pending” buttons are selected, the filters are turned off, and all pending and completed STICKY NOTES are displayed. Finally, the last menu item is called “edit,” which activates a delete button around the STICKY NOTE (e.g., displaying on the right on iOS platforms) that allows the user to remove pending and completed STICKY NOTES from the list. Moreover, deleting a pending STICKY NOTE will cancel its future delivery.

Turning back to FIG. 3, below the menu bar is a list of pending and/or completed STICKY NOTES, as the filters allow to be displayed. The list contains abridged information related to the STICKY NOTE, which could contain between one or more lines of text, depending on the user's preferences. In this figure, the user has selected to show 3 lines of text per STICKY NOTE, which would show at least the first phrase of the message (e.g., <50 characters), the recipient(s)'s name(s), the delivery date and time, and the status of the STICKY NOTE (e.g., pending, transmitting, delivered, displayed, completed, cancelled, etc.).

### Preferred Process

For the purposes of this disclosure, it is assumed that the user has already signed-up to use the system (agreed to terms and conditions, established user names, passwords, etc.), as well as connected his/her messaging services (e.g., email, cell number, instant message accounts, etc.) on the relevant application on the SENDER DEVICE and/or RECEIVER DEVICE. These steps, while varied, are well known and appreciated by those with ordinary skill in the art, and thus, will not be described herein.

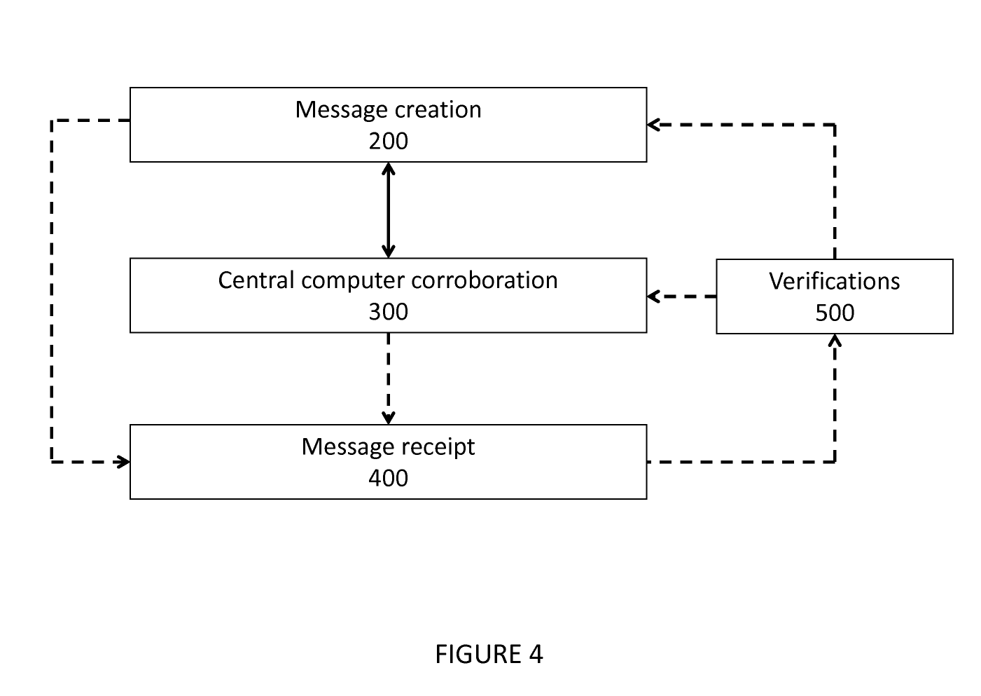

As shown in FIG. 4, the preferred method for creating and distributing time-delayed electronic messages and notifications on mobile devices involves the following major steps: (a) message creation 200; (b) central computer corroboration 300; (c) message receipt 400. Where possible, the preferred method will also provide the user with verification of the delivery and display of a STICKY NOTE, herein called verifications 500.

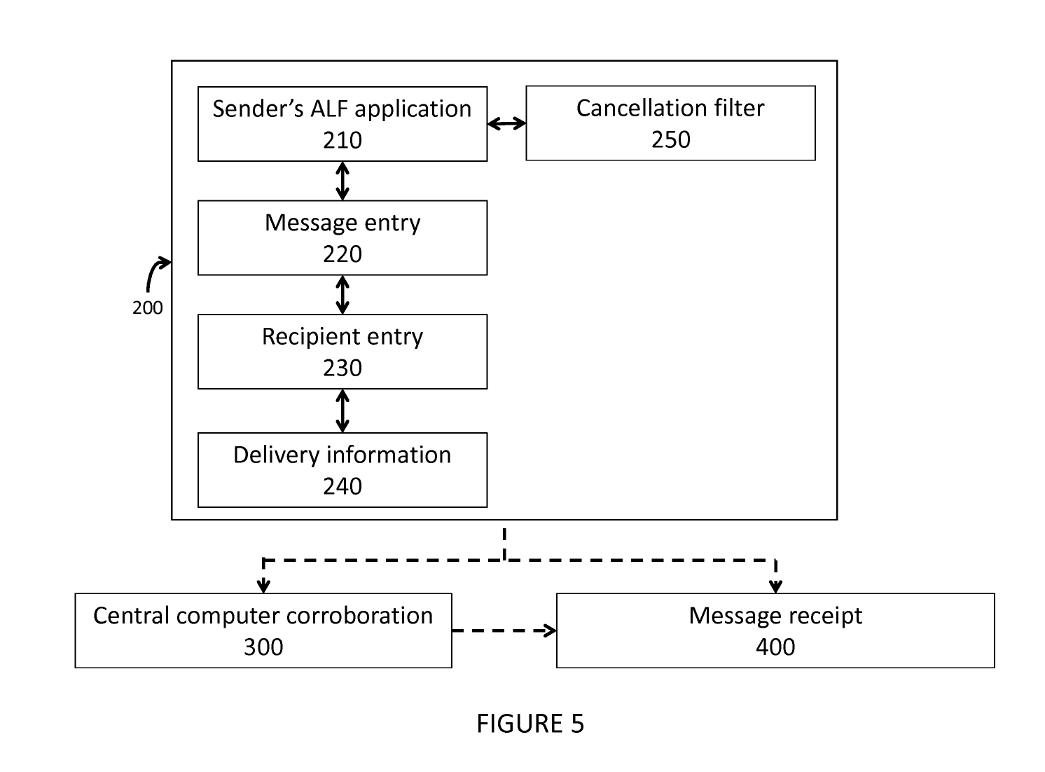

As shown in FIG. 5, the preferred method for message creation 200, commences with the user authenticating himself/herself on the system from a network-enabled Sender's ALF application 210 on the SENDER DEVICE. Through the Sender's ALF application 210 (which is a software which facilitates use of the invention), the user inputs (1) a text, video, voice, or other electronic message (message entry 220); (2) adds the recipients address (email, phone number, IM handle, etc.) either manually or by selecting it from the contact list (Recipient Entry 230); and (3) the user selects the date and time of delivery (Delivery information 240). Thereafter, the STICKY NOTE is dispatched from the SENDER DEVICE for central computer corroboration 300 and/or message receipt 400, as further explained infra.

In an alternative, Delivery information 240 may include other qualifiers for delivery. For example, the user may select a geo-location in addition to, or in the alternative of a date and time. To illustrate this point, imagine that the sender who wishes to send his colleagues a message on Monday morning at 8:45 a.m. believes that one of his colleagues will be having breakfast with an important client outside the office on Monday morning. To limit the distraction, the user may set a condition that the message should only be delivered at 8:45 a.m. when the recipient is within the vicinity of the office.

The user also has the option of deleting or cancelling delivery of the STICKY NOTE prior to its display on the RECEIVER DEVICE (Cancellation filter 250). Assuming that the message is cancelled before dispatch, the message is simply removed from list of messages to be sent. However, if the message has already been dispatched, then the Sender's ALF Application will send a second computer-coded notification to the CENTRAL COMPUTER that in turn, sends a second instruction the RECEIVER DEVICE to refrain from displaying the STICKY NOTE, even if the display conditions are satisfied (e.g., it is 8:45 am), provided that the cancellation notification is received prior to such display conditions precedent.

Referring back to FIG. 4, the second and third major steps is central computer corroboration 300 and message receipt 400. At its core, central computer corroboration 300 determines whether the STICKY NOTE should be stored on the RECEIVER DEVICE or the SENDER DEVICE, for later delivery and display (message receipt 400). In other words, the CENTRAL COMPUTER determines whether (1) the RECEIVER DEVICE contains a complementary ALF application (containing relevant parts of the invention) that will allow the RECEIVER DEVICE to display a time-delayed STICKY NOTE; or (2) whether the STICKY NOTE should be held in abeyance by the SENDER DEVICE for later delivery. As these processes are intertwined, it is most appropriate to describe them together.

One method for accomplishing the second major step (central computer corroboration 300) is for the CENTRAL COMPUTER to send a unique computer-coded request to the RECEIVER DEVICE using always-open IP connection and/or push technology, which is then read by the RECEIVER DEVICE. Assuming that the RECEIVER DEVICE has the ALF application, THE RECEIVER DEVICE is then programmed to return a corresponding computer-coded confirmation to the CENTRAL COMPUTER that tells the CENTRAL COMPUTER that the RECEIVER DEVICE can receive and display time-delayed STICKY NOTES. A preferred method for sending these computer-coded requests and confirmations generally employs encryption and/or other user authentication techniques, which are well known and appreciated, and not described in detail herein. While these computer-coded requests and confirmations may be displayed to the users, it is preferred if they are not.

Assuming that the RECEIVER DEVICE has the complementary ALF application, the CENTRAL COMPUTER will return a corresponding computer-coded message to the SENDER DEVICE (using push technology). This returned computer-coded message confirms to the SENDER DEVICE that it should dispatch the STICKY NOTE to the RECEIVER DEVICE via the NETOWRK (either directly or via the CENTRAL COMPUTER). Message receipt 400 is then accomplished by passing the STICKY NOTE from the SENDER DEVICE, through the NETWORK—either directly or via the CENTRAL COMPUTER—to the RECEIVER DEVICE. The message is likewise sent, by push technology, either through unrelated communication servers on the NETWORK, or in the alternative, through the CENTRAL COMPUTER, as deemed best determined by quality of service protocols.

Alternatively, if the RECEIVER DEVICE does not have the complementary ALF application, then Message receipt 400 is accomplished by an alternative means. In this condition, the CENTRAL COMPUTER notifies the SENDER DEVICE to hold the STICKY NOTE in abeyance in its database of messages to be pushed out to the RECEIVER DEVICE at the specified delivery date and time (or as other conditions of dispatch dictate). In other words, the STICKY NOTES are held on the SENDER DEVICE until such time as the delivery qualifiers (e.g., date and time, location, etc.) as identified in the STICKY NOTE's header are fulfilled. When the conditions in the STICKY NOTE's header are satisfied (e.g., that it is 8:45 am on Monday morning, etc.), the SENDER DEVICE delivers the STICKY NOTE to the RECEIVER DEVICE using standard messaging protocols. If the conditions are not satisfied, then the STICKY NOTE's delivery/display may timeout after a system-specified time (e.g., 1 year).

Assuming successful delivery of the STICKY NOTE at the appropriate date and time, the complementary ALF application on the RECEIVER DEVICE will notify recipient with the message of the STICKY NOTE with a notification (usually a pop-up message), and an entry in the notification center of the complementary ALF application on the RECEIVER DEVICE (if set in the user preferences).

Upon receipt of the STICKY NOTE, the complementary ALF application on the RECEIVER DEVICE will allow the recipient to send an acknowledgement message or thank you message back to the SENDER DEVICE for immediate delivery through the push notification system used in the original sending of the sticky note. This essentially begins the same process described above, but in reverse.

It is important to note that time and date of delivery information as contained on the STICKY NOTE header, whether later sent to the CENTRAL SERVER and/or the RECEIVER DEVICE, is translated across time zones so that they synchronize with the time and date from the SENDER DEVICE at the time sent, or as otherwise specified by the user. Therefore, if the sender is in California on Friday night at 11:30 pm (setting a meeting reminder at 8:45 a.m. on Monday), and later travels to New York on Sunday night, the STICKY NOTE will still be set to deliver/display at 8:45 a.m. pacific standard time on Monday (or 5:45 a.m. Eastern Standard Time). Likewise, the recipient's STICKY NOTE will be translated to the local time that synchronizes with the Sender's time zone (e.g., the receiver's device will display the message at 9:45 am if he/she is geographically located in an area operating on central time). Multi-zone time stamping is a well-studied area, with a number of methodologies designed to overcome the problem, any of which may be employed here. Final selections of such methodologies will usually be dictated by operating platforms on the SENDER DEVICE, RECEIVER DEVICE, CENTRAL COMPUTER, and/or other factors.

Referring back to FIG. 5, in the preferred method includes verifications 500. Not surprisingly, the frequency and variety of verifications will depend on whether the RECEIVER DEVICE has the complementary ALF application.

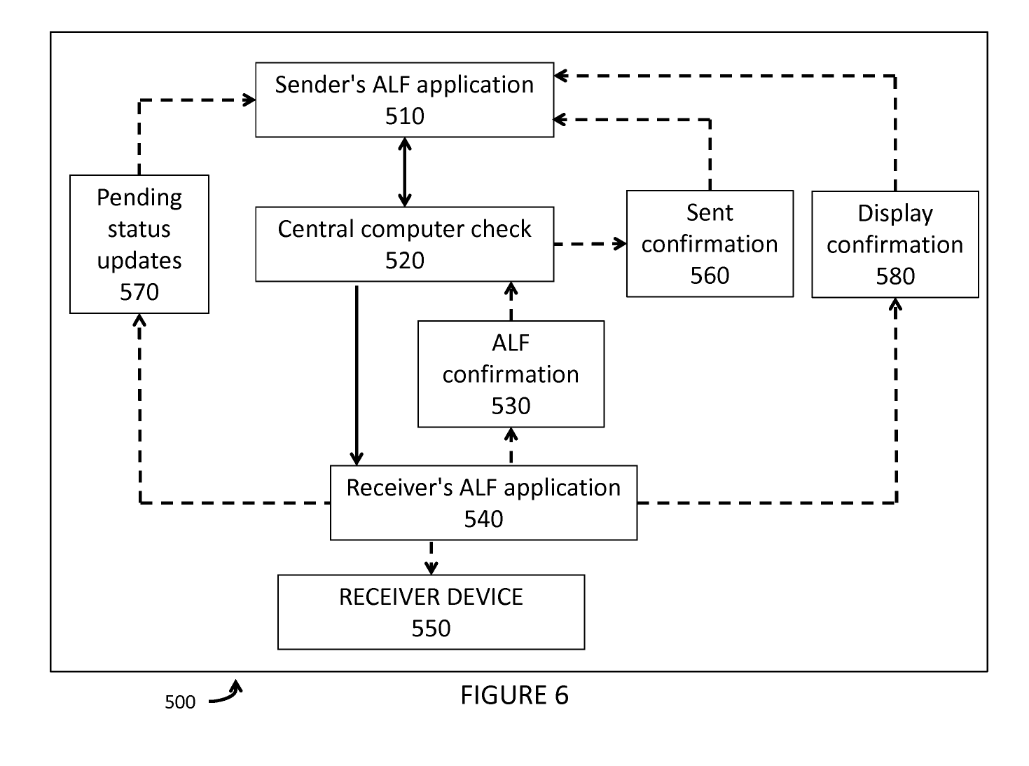

While explained in detailed in preceding paragraphs, a diagram, as shown in FIG. 6, is helpful to further explain the method for determining the kinds of verification possible to be sent. In the qualifying step, the preferred method is for the Sender's ALF application 510 to perform a central computer check 520, whereby the Sender's ALF application 510 sends a computer-coded request to the CENTRAL COMPUTER, which in turn, passes that request to the RECEIVER DEVICE 550 to determine whether the Receiver's ALF application 540 is installed and operating. If the Receiver's ALF application 540 is installed, the RECEIVER DEVICE is programmed to return a confirmation (ALF confirmation 530) to the central computer check 520 sequence, which in turn, returns the same confirmation back to the Sender's ALF application 510. This handshaking procedure may use any variety of encryption and/or other user authentication techniques, all of which are well-known and appreciated in the art. The nature and type of handshaking sequence will depend on the operating system on each device, and will require cross-platform compatibility.

In the preferred method, the CENTRAL COMPUTER will maintain a database of all users whom have a ALF application installed, thereby limiting the number of times that such authentication is required. The preferred method will use an optimized scheme (depending on quality of service protocols) to perform periodic checks to confirm that all user's applications are active (minutes, hours, days, months) or simply based on confirmation of last successful STICKY NOTE display. Alternatively, or in addition the above referenced authentication of routing procedures, the central computer check 520 will perform a new authentication if status updates are not timely returned.

If the receiver's ALF application 540 cannot be verified, then by default, the transmitted STICKY NOTES are held in abeyance on the SENDER DEVICE until the STICKY NOTE's header conditions are satisfied. Upon satisfaction of said conditions, the SENDER DEVICE will send the STICKY NOTE directly through the SENDER DEVICE using standard communication (e.g., sms messaging, IM, email, etc.). If available, confirmations of receipt may be returned through native STICKY NOTE messaging protocols (e.g., as sometimes found on SMS or chat messages, etc.).

However, if the receiver's ALF application 540 is verified as operating, then additional types of verifications are possible. Here, the Receiver's ALF application 540 will use an alternate protocol to send a greater variety of pending status updates 570 (e.g., pending, transmitting, delivered, displayed, completed, cancelled, etc.) rather than using the sent confirmations 560 protocol. As applicable, these status updates are sent using push technology to the SENDER device, either directed through unrelated servers on the NETWORK, or directly through the CENTRAL COMPUTER. Moreover, these status updates, may be stored on one or more databases on the CENTRAL COMPUTER as part of transactional logs and/or other informational purposes. Finally, when the STICKY NOTE is displayed on the RECEIVER DEVICE, the Receiver's ALF application 540, will return a final display confirmation 580 to the SENDER DEVICE, which concurrently discontinues operation of the pending status updates 570 protocols. Pending status updates 570 and display confirmations 580 may be used independently, or in conjunction with, native STICKY NOTE messaging protocols (e.g., confirmation of receipts of SMS or chat messages, etc.).

In the event that verifications are not returned to either the CENTRAL COMPUTER and/or SENDER DEVICE, the preferred system may include a backup messaging system (e.g., SMS or email) in which the SENDER DEVICE sends a copy of the STICKY NOTE, providing an added layer of protection against a missed communication. The back-up system may be enabled in pre-defined intervals (e.g., 10 minutes after missed verification) as set by the ALF application settings and/or by the user.

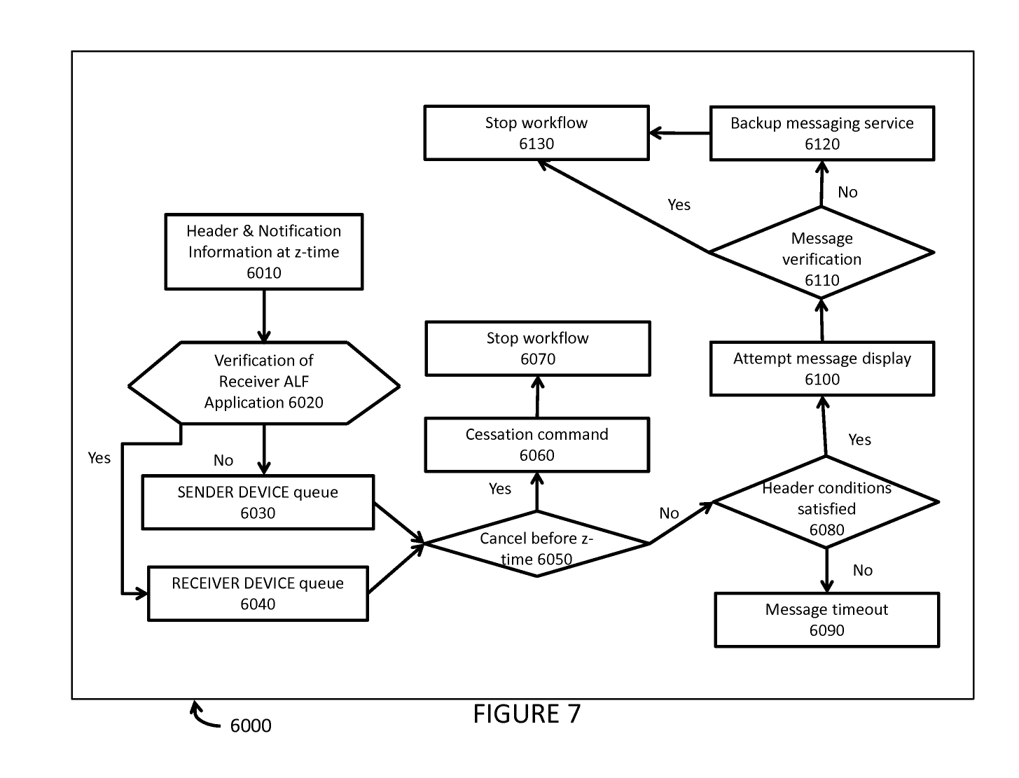

To sum the invention up, and as shown in FIG. 7, the preferred method for creating and distributing time-delayed electronic messages and notifications on mobile devices, could be explained from a different viewpoint in the workflow diagram shown. Process 6000 attempts to explain the workflow for creating and to delivering time-delayed STICKY NOTEs, which first begins by inputting the message and delivery information (starting block 6010), transmitting an abridged request to the CENTRAL SERVER which determines if the RECEIVER DEVICE has an operational ALF application (action block 6020). If the RECEIVER DEVICE has an operational ALF application, then the STICKY NOTE is transferred to the RECEIVER DEVICE message queue (action block 6030). If not, the STICKY NOTE is transferred to the SENDER DEVICE messaging queue (action block 6040), as directed by CENTRAL COMPUTER notification.

Thereafter, the sender has the option of cancelling delivery of the STICKY NOTE before the delivery time (action block 6050). If the message is cancelled, a corresponding computer-coded message is sent to the CENTRAL COMPUTER and/or the RECEIVER DEVICE, informing the applicable system to refrain from displaying the STICKY NOTE (action block 6060), with the workflow thereafter stopping (action block 6070).

If delivery is not cancelled timely, then the message remains in the queue on the SENDER DEVICE and/or the RECEIVER DEVICE until the conditions in the STICKY NOTE's header are satisfied (action block 6080). If the conditions are not satisfied, then the STICKY NOTE's delivery/display may timeout after a system-specified time (e.g., 1 year) (action block 6090).

However, if the header conditions are satisfied, the SENDER DEVICE and/or RECEIVER DEVICE will attempt to deliver and display the STICKY NOTE to the receiver (action block 6100), which, if successful, causes the RECEIVER DEVICE and/or the CENTRAL COMPUTER to return a delivered and/or displayed verification message to the SENDER DEVICE (action block 6110). If the verification is successfully returned, the workflow stops (action block 6130). If unsuccessful, the RECEIVER DEVICE and/or CENTRAL SERVER may make several attempts to send the STICKY NOTE through alternative means (action block 6120), before stopping the workflow (action block 6130).

Any of the above-described processes and methods may be implemented by any now or hereafter known computing device. For example, the methods may be implemented in such a device via computer-readable instructions embodied in a computer-readable medium such as a computer memory, computer storage device or carrier signal.

The preceding described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims that appear in the final non-provisional application.

What is claimed is:

1. A system for creating and distributing time-delayed electronic messages and notifications on mobile devices comprising:
a consumer communication device operatively coupled to a computer program product and a public network, the computer program product having a computer-usable medium having a sequence of instructions which, when executed by a processor, causes said processor to execute a process that communicates with a central computer server and/or other mobile devices to deliver time-delayed messages, said process comprising;
creating a message;
corroborating with a central server that receiver device(s) have the ability to display time delayed messages;
routing messages to the sender or receiver's message queue;
sending and/or displaying a message based on a user's time-delay criteria;
electronically publishing information related to a message's status to the consumer communication device.
